(19) United States
(12) Patent Application Publication
(10) Pub. No.: US 2014/0120862 A1
(43) Pub. Date: May 1, 2014

(54) CLOUD SERVER AND METHOD OF EMERGENCY RESPONSE SERVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/020,914

(22) Filed: Sep. 9, 2013

(30) Foreign Application Priority Data
Oct. 26, 2012 (TW) 101139665

(51) Int. Cl. H04W 4/22

(52) U.S. Cl. CPC H04W 4/22
USPC 455/404.2

(57) ABSTRACT

In a method of an emergency response service using a cloud server, the cloud server communicates with a terminal device installed in a vehicle through a wireless network. The terminal device sends driving information of the vehicle to the cloud server through the wireless network. The cloud server determines whether the vehicle is involved in an emergency by analyzing the driving information of the vehicle, and obtains a real-time position of the vehicle from the driving information of the vehicle when the emergency happens to the vehicle. The cloud server generates a telephone contact list including a telephone number of a rescue center nearby the vehicle, generates rescue information according to the basic information and the driving information of the vehicle, and sends the rescue information to the rescue center according to the telephone contact list.

### BACKGROUND

1. Technical Field

Embodiments of the present disclosure relate to a emergency response systems and methods, and particularly to a cloud server and method of an emergency response service.

2. Description of Related Art

A person who reports an accident should remain at the scene of the accident until first responders or rescuers arrive. However, the effectiveness of the report and the rescue can be diminished if the person reporting the accident leaves the scene before the first responders or rescuers arrive. The effectiveness can also be diminished by uncertainties such as the failure of the reporting system, failure to reach the administrator of the report system or the responders, or the responders cannot arrive on the scene in time. Furthermore, some rescue methods are unfamiliar to most people.

What is needed, therefore, is an emergency response system capable of overcoming the limitation described.

### BRIEF DESCRIPTION OF THE DRAWINGS

FIG. 1 is a block diagram of one embodiment of a cloud server including a emergency response system.

FIG. 2 is a flowchart of one embodiment of a method of an emergency response service using a terminal device of FIG. 1.

FIG. 3 is a flowchart of one embodiment of a method of an emergency response service using the cloud server of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

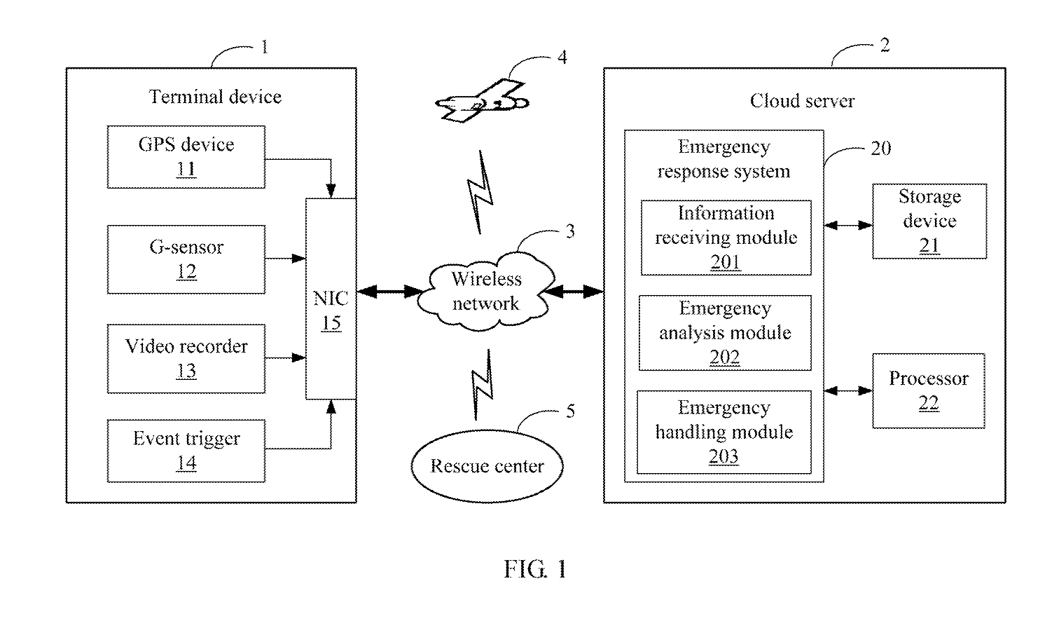

FIG. 1 is a block diagram of one embodiment of a cloud server 2 including an emergency response system 20. In the embodiment, the emergency response system 20 is implemented by the cloud server 2, and reports emergency information of a vehicle to a rescue center 5 when the vehicle is involved in an emergency. In the embodiment, the emergency may include a vehicular accident and an emergency incident of the vehicle while driving. The cloud server 2 connects with a terminal device 1 through a wireless network 3 implemented according to a Global Position System (GPS) 4. The rescue center 5 can communicate with the terminal device 1 and the cloud server 2 through the wireless network 3. The wireless network 3 may be a 3G network, a 4G network, a WIFI network, or a Global System for Mobile Communications (GSM) network. The GPS 4 provides a GPS service for locating the real-time position of the vehicle. The rescue center 5 may include, but is not limited to, a police station, a hospital, an ambulance, and an insurance company of the vehicle.

The terminal device 1 includes, but is not limited to, a GPS device 11, a gravity sensor (G-sensor) 12, a video recorder 13, an event trigger 14, and a network interface card (NIC) 15. The GPS device 11, the G-sensor 12, the video recorder 13, and the event trigger 14 are connected to the NIC 15. The terminal device 1 can be attached to the dashboard or installed in the vehicle, and communicates with the cloud server 2 using the NIC 15 through the wireless network 3 in real time. In one embodiment, the terminal device 1 may be a mobile phone, a Personal Digital Assistant (PDA) device, or any other mobile communication device.

The GPS device 11 acquires a real-time position of the vehicle, the G-sensor 12 senses a real-time speed of the vehicle, and the video recorder 13 records video stream of the vehicle when the vehicle is in motion. The event trigger 14 generates driving information of the vehicle according to the real-time position, the real-time speed and the video stream of the vehicle, and sends the driving information of the vehicle to the cloud server 2 through the wireless network 3. In order to occupy as little of the network resource as possible, the event trigger 14 only sends a part of the video stream, which is recorded between before 10 minutes and after 5 minutes of occurrence of the emergency, to the cloud server 2 through the wireless network 3. The NIC 15 maintains the terminal device 1 is connected to the cloud server 2 wirelessly.

The cloud server 2 further includes, but is not limited to, a storage device 21 and at least one processor 22. The storage device 21 stores basic information of the vehicle and driving information of the vehicle. The basic information of the vehicle may include a vehicle number, a name of an owner of the vehicle, a telephone number of the owner, telephone numbers of the rescue center 5, such as a telephone number of an insurance company. The driving information of the vehicle includes the real-time position, the real-time speed and the video stream of the vehicle.

In one embodiment, the storage device 21 may be an internal storage system, such as a random access memory (RAM) for temporary storage of information, and/or a read only memory (ROM) for permanent storage of information. The storage device 21 may also be an external storage system, such as an external hard disk, a storage card, network attached storage (NAS), a web database, or a data storage medium. The at least one processor 22 is a central processing unit (CPU) or microprocessor that performs various functions of the cloud server 2.

In one embodiment, the emergency response system 20 includes an information receiving module 201, an emergency analysis module 202, and an emergency handling module 203. The modules 201-204 may comprise computerized instructions in the form of one or more computer-readable programs that are stored in a non-transitory computer-readable medium (such as the storage device 21) and executed by the at least one processor 22.

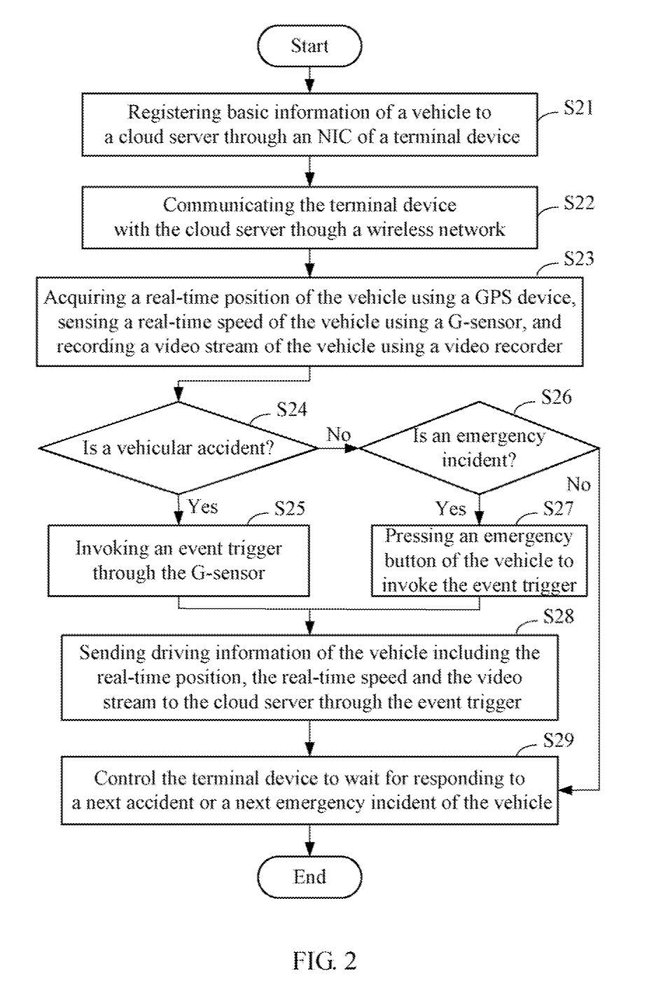

FIG. 2 is a flowchart of one embodiment of a method of an emergency response service using the terminal device 1 of FIG. 1. In the embodiment, the method uses the terminal device 1 to send the driving information of the vehicle to the cloud server 2 when the vehicle is involved in an emergency. The emergency may include a vehicular accident and an emergency incident of the vehicle while driving. Depending on the embodiment, additional steps may be added, others removed, and the ordering of the steps may be changed.

In step S21, the terminal device 1 registers basic information of the vehicle to the cloud server 2 using the NIC 15. In the embodiment, the basic information of the vehicle may include a vehicle number, a name of an owner of the vehicle, a telephone number of the owner, telephone numbers of the rescue center 5, such as a telephone number of an insurance company.

In step S22, the terminal device 1 communicates with the cloud server 1 using the NIC 15 though the wireless network 3 in real time.

In step S23, the GPS device 11 acquires a real-time position of the vehicle, the G-sensor 12 senses a real-time speed of the vehicle, and the video recorder 13 records video stream of the vehicle, when the vehicle is in motion.

In step S24, the G-sensor 12 determines whether the vehicle is involved in an accident according to the real-time speed of the vehicle and the video stream of the vehicle. If the vehicle is involved in an accident, step S25 is implemented. Otherwise, step S26 is implemented.

In step S25, the G-sensor 12 invokes the event trigger 14 automatically. In step S26, the G-sensor 12 determines whether the vehicle is involved in an emergency incident. In one embodiment, the G-sensor 12 determines that the vehicle is involved in an emergency incident when the driver presses an emergency button of the vehicle. If the vehicle is involved in an emergency incident, step S27 is implemented. If the vehicle is not involved in an emergency incident, step S29 is implemented.

In step S27, the driver presses an emergency button of the vehicle to invoke the event trigger 14. In step S28, the event trigger 14 sends driving information of the vehicle including the real-time position, the real-time speed and the video stream of the vehicle to the cloud server 2 through the wireless network 3. In step S29, the NIC card 15 controls the terminal device 1 to wait for in respond to a next vehicular accident or in respond to a next emergency incident.

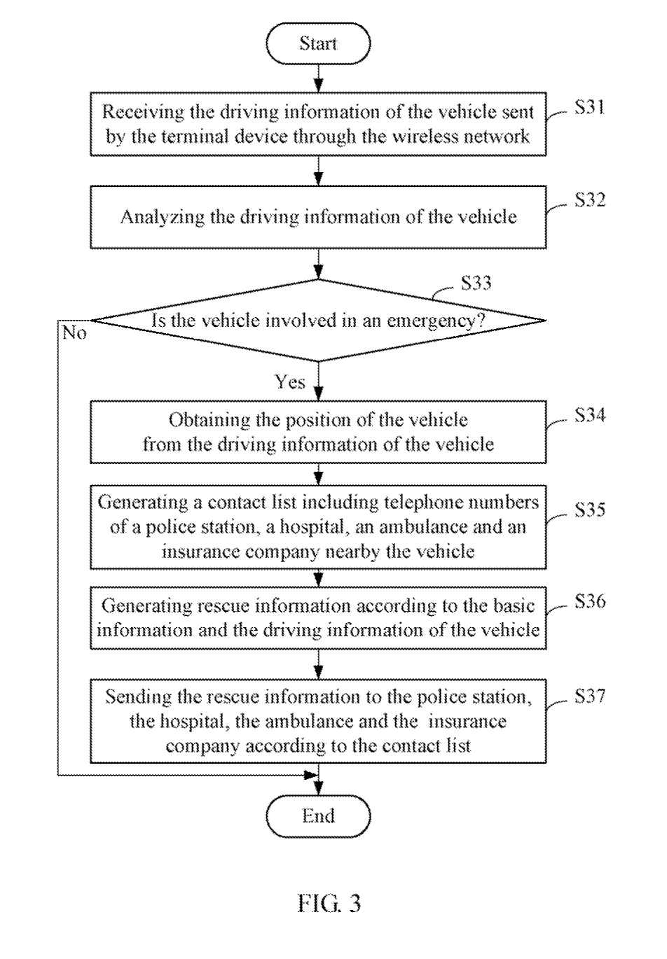

FIG. 3 is a flowchart of one embodiment of a method of an emergency response service using the cloud server 1 of FIG. 1. The method is performed by execution of computer-readable program codes or instructions stored in the storage device 21 and executed by the at least one processor 22. In the embodiment, the method uses the cloud server 2 to send the rescue information of the vehicle to the rescue center 5 when an emergency happens to the vehicle. Depending on the embodiment, additional steps may be added, others removed, and the ordering of the steps may be changed.

In step S31, the information receiving module 201 receives the driving information of the vehicle sent by the terminal device 1 through the wireless network 3, and stores the driving information of the vehicle into the storage device 22. In the embodiment, the terminal device 1 sends the driving information of the vehicle including the real-time position, the real-time speed and the video stream of the vehicle to the cloud server 2 when the emergency happens to the vehicle.

In step S32, the emergency analysis module 202 analyzes the driving information of the vehicle. In the embodiment, the emergency analysis module 202 analyzes the driving information of the vehicle to obtain the real-time position, the real-time speed and the video stream of the vehicle.

In step S33, the emergency analysis module 202 determines whether the vehicle is involved in an emergency. In the embodiment, the emergency may include a vehicular accident and an emergency incident of the vehicle while driving. The emergency analysis module 202 determines whether the vehicle is involved in an emergency according to the real-time speed and the video stream of the vehicle. If whether the vehicle is involved in an emergency, step S34 is implemented. If whether the vehicle is not involved in an emergency, the flows goes to end.

In step S34, the emergency analysis module 202 obtains the real-time position of the vehicle from the driving information of the vehicle.

In step S35, the emergency handling module 203 generates a telephone contact list including telephone numbers of the rescue center 5 including a police station, a hospital, an ambulance and an insurance company nearby the vehicle.

In step S36, the emergency handling module 203 generates rescue information according to the basic information and the driving information of the vehicle. In the embodiment, the rescue information may include the basic information of the vehicle including a vehicle number, a name of an owner of the vehicle, and a telephone number of the owner, and the driving information of the vehicle including the real-time position, the real-time speed and the video stream of the vehicle.

In step S37, the emergency handling module 203 sends the rescue information to the rescue center 5 including the police station, the hospital, the ambulance and the insurance company according to the telephone contact list. In one embodiment, the emergency handling module 203 sends a message (e.g., a SMS message or a MMS message) including the rescue information of the vehicle to the rescue center 5 according to the telephone contact list. In other embodiments, the emergency handling module 203 may send a voice message to the rescue center 5 or call a telephone number of the rescue center 5, such as 911 of the police station, for example.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud server being connected with a terminal device installed in a vehicle through a wireless network, the cloud server comprising:
at least one processor; and
a storage device storing a computer-readable program including instructions that, which when executed by the at least one processor, causes the at least one processor to:
receive driving information of the vehicle sent by the terminal device through the wireless network, wherein the driving information of the vehicle comprises a real-time position, a real-time speed and a video stream of the vehicle;
determine whether the vehicle is involved in an emergency by analyzing the driving information of the vehicle;
obtain the real-time position of the vehicle from the driving information of the vehicle when the vehicle is involved in the emergency;
generate a telephone contact list including a telephone number of a rescue center nearby the vehicle;
generate rescue information according to the basic information and the driving information of the vehicle; and
send the rescue information to the rescue center according to the telephone contact list.

2. The cloud server according to claim 1, wherein the terminal device comprises a global position system (GPS) device that acquires the real-time position of the vehicle.

3. The cloud server according to claim 1, wherein the terminal device comprises a G-sensor that senses the real-time speed of the vehicle when the vehicle is in motion.

4. The cloud server according to claim 1, wherein the terminal device comprises a video recorder that records the video stream of the vehicle between before 10 minutes and after 5 minutes when the vehicle is involved in the emergency.

5. The cloud server according to claim 1, wherein the terminal device comprises an event trigger that sends the driving information of the vehicle to the cloud server through the wireless network when the vehicle is involved in the emergency.

6. The cloud server according to claim 1, wherein the terminal device comprises a network interface card (NIC) that registers basic information of the vehicle to the cloud server and maintains the terminal device connected to the cloud server in wireless.

7. The cloud server according to claim 1, wherein the rescue center comprises a police station, a hospital, a ambulance and an insurance company.

8. The cloud server according to claim 1, wherein the computer-readable program further causes the at least one processor to send a voice message to the rescue center or call the telephone number of the rescue center.

9. A computerized method of an emergency response service using a cloud server, the cloud server being connected with a terminal device installed in a vehicle through a wireless network, the method comprising:
receiving driving information of the vehicle sent by the terminal device through the wireless network, wherein the driving information of the vehicle comprises a real-time position, a real-time speed and a video stream of the vehicle;
determining whether the vehicle is involved in an emergency by analyzing the driving information of the vehicle;
obtaining the real-time position of the vehicle from the driving information of the vehicle when the vehicle is involved in the emergency;
generating a telephone contact list including a telephone number of a rescue center nearby the vehicle;
generating rescue information according to the basic information and the driving information of the vehicle; and
sending the rescue information to the rescue center according to the telephone contact list.

10. The method according to claim 9, wherein the terminal device comprises a global position system (GPS) device that acquires the real-time position of the vehicle.

11. The method according to claim 9, wherein the terminal device comprises a G-sensor that senses the real-time speed of the vehicle when the vehicle is in motion.

12. The method according to claim 9, wherein the terminal device comprises a video recorder that records the video stream of the vehicle between before 10 minutes and after 5 minutes when the vehicle is involved in the emergency.

13. The method according to claim 9, wherein the terminal device comprises an event trigger that sends the driving information of the vehicle to the cloud server through the wireless network when the vehicle is involved in the emergency.

14. The method according to claim 9, wherein the terminal device comprises a network interface card (NIC) that registers the basic information of the vehicle to the cloud server and maintains the terminal device connected to the cloud server in wireless.

15. The method according to claim 9, wherein the rescue center comprises a police station, a hospital, a ambulance and an insurance company.

16. The method according to claim 9, further comprises a step of sending a voice message to the rescue center or calling the telephone number of the rescue center.

17. A non-transitory storage medium having stored thereon instructions that, when executed by at least one processor of a cloud server, cause the processor to perform a method of an emergency response service, the cloud server being connected with a terminal device installed in a vehicle through a wireless network, the method comprising:
receiving driving information of the vehicle sent by the terminal device through the wireless network, wherein the driving information of the vehicle comprises a real-time position, a real-time speed and a video stream of the vehicle;
determining whether the vehicle is involved in an emergency by analyzing the driving information of the vehicle;
obtaining the real-time position of the vehicle from the driving information of the vehicle when the vehicle is involved in the emergency;
generating a telephone contact list including a telephone number of a rescue center nearby the vehicle;
generating rescue information according to the basic information and the driving information of the vehicle; and
sending the rescue information to the rescue center according to the telephone contact list.

18. The storage medium according to claim 17, wherein the terminal device comprises a network interface card (NIC) that registers basic information of the vehicle to the cloud server and maintains the terminal device connected to the cloud server in wireless.

19. The storage medium according to claim 17, wherein the rescue center comprises a police station, a hospital, a ambulance and an insurance company.

20. The storage medium according to claim 17, wherein the method further comprises sending a voice message to the rescue center or calling the telephone number of the rescue center.
